(19) United States
(12) Patent Application Publication
(10) Pub. No.: US 2005/0128064 A1
(43) Pub. Date: Jun. 16, 2005

(54) VEHICLE ALARM SYSTEM

(75) Inventor: SCOTT A RIESEBOSCH, WELLAND ONTARIO (CA)

Correspondence Address: SCOTT ARTHUR RIESEBOSCH, 129 HAGAR STREET, UNIT # 5, WELLAND ONTARIO, L3B 5V9, CA

(73) Assignee: CRS ELECTRONICS, WELLAND (CA)

(21) Appl. No.: 10/907,045

(22) Filed: Mar. 17, 2005

(51) Int. Cl. B60Q 1/00

(52) U.S. Cl. 340/457

(57) ABSTRACT

There is provided a new and useful alarm system for use on a school bus that ensures that drivers walk through the inside of a vehicle prior to exiting. Once the vehicle ignition system has been in the on position for a specified period of time, or the vehicle has traveled at or above a pre-determined speed, the system will enter a set state. The system may also feature means for turning on the interior lights of the vehicle to aid the driver during their visual sweep of the vehicle. The system may also feature means for dis-engaging deactivation means at the rear of the vehicle if it is in the alarm state.

### FIELD OF THE INVENTION

This invention relates to an alarm system for use on a vehicle to remind the driver of the vehicle to conduct an inspection of the inside of the vehicle.

### BACKGROUND OF THE INVENTION

In order to ensure that no children are left on a bus, drivers are trained to walk to the back of the bus to look for children who may still be onboard at the end of a run. Many children fall asleep aboard school buses each year, and quite often do not get noticed by the driver because the driver exits the bus without walking through it first. Children have perished from excessive heat and have suffered hypothermia in excessive cold. Many have experienced emotional distress. These unfortunate occurrences have also resulted in lawsuits filed by parents, and countless drivers of many years experience being fired.

There exists a need for a system on the bus that will remind a driver to conduct a visual sweep of the bus before exiting. An audible or visual alarm system which sounds when the bus ignition is turned off is not sufficient. After speaking with numerous school districts using such systems, it was discovered that these systems were being bypassed by drivers by simply walking around the outside of the school bus and reaching in through the back door to press the deactivator. Moreover, these types of alarms typically sound the vehicle horn if the driver has not walked to the back of the bus within 30 to 60 seconds after shutting off the ignition. This timing method distracts the driver during their visual sweep because the horn will begin honking if they do not reach the back of the bus quickly. In addition, drivers can walk a considerable distance from their bus before the horn will sound. With a yard full of school buses, most drivers don't realize it is their bus that is sounding the alarm and they keep walking away even when the alarm sounds.

A system that can be deactivated with the ignition in the on position can also be bypassed quite easily. Since children are riding the bus while the ignition is on, drivers can easily ask one of the children onboard to press the deactivator at the rear of the bus prior to disembarking at school. The driver is then free to drive back to the bus yard and go home without walking through and conducting their visual sweep. There have been a number of children left on school buses protected by this type of system because of this fundamental flaw.

In addition, any alarm system designed to make certain drivers perform a visual sweep of their buses prior to exiting at the end of their runs should automatically allow service personnel to perform service work on the vehicle with minimal inconvenience. It should also provide mechanics with a fast, simple means to verify that the system is operational. Every type of alarm system on the market today suffers from a common problem; mechanics disable them during service work because it is inconvenient to keep walking to the back of the bus. Some systems have mechanic override keys to accommodate mechanics. However, the override keys typically end up in the hands of the drivers themselves within days of installation of the system, rendering it useless. Other systems only require the driver to check the bus if the overhead warning lights have been used, meaning that unless the mechanics turn the warning lights on, they will not have to walk to the back. This creates a serious problem because most school buses are used for field trips, athletic events, and other runs where there are children onboard but the warning lights are not used. These types of systems would not provide any protection in such cases. Even a system that would arm by using the brake pedal or other device on the bus would not be effective because it would either inconvenience the mechanics or would require some specific action to be taken by the driver to arm the system.

Disabled systems are a serious concern to school bus operators. Many of them are installing alarm systems in their fleets in an effort to make sure drivers check their buses for sleeping children, only to find the systems are not functioning because they have been unplugged or disabled.

Another problem is caused by poor visibility inside the vehicle. Even though a driver may perform their visual sweep of the bus, it does not necessarily mean they will see a sleeping child if it is an overcast day, or at night when low light levels are present. A system that requires drivers to check the buses for sleeping children should automatically illuminate the interior of the vehicle, helping the driver see in and under the seats.

Attempts in the prior art to design such a system have failed on the key points outlined above and would not satisfy the aspect of providing mechanics a grace period, a speed activated system, or a simple, quick means for verifying that the system is functional. There is also no mention of illuminating the interior of the vehicle to aid the driver during their visual sweep. There is also no mention of rendering the deactivation means at the rear section of the vehicle inoperable if the system has entered the alarm state. Reference may be had for example U.S. Pat. No. 5,128,651 of Heckart, issued Jul. 7, 1992, and U.S. Pat. No. 5,243,323 of Rogers, issued Sep. 7, 1993, and U.S. Pat. No. 5,874,891 of Lowe, issued Feb. 23, 1999. None of these references provides a means to delay the arming of the system until after the ignition has been in the on position for a set period of time to give mechanics enough time to bring the bus from its parking location to the service bay. None of these references provides a means to delay arming of the system until after the vehicle has reached a pre-determined speed, thus allowing mechanics to shuttle buses around the parking lot at below traffic speeds. None of these references provides a means for simple, quick verification that the system is functioning and has not been disabled. None of these references provides means for illuminating the interior of the vehicle to help the driver see in and under the seats. None of these references provides means for disabling deactivation means at the rear of the vehicle if the system has entered the alarm state. Heckart is deficient because it effects the armed state if the pupil loading door has been opened. Most mechanics open these doors during service work, which would arm the system and cause mechanics to get frustrated and disable the system. Rogers is deficient because it arms immediately if the ignition is turned on, and would definitely be a major inconvenience for service personnel. Rogers attempts to compensate for this inconvenience with an override key, but as mentioned earlier, such keys end up in the hands of the drivers rending the system useless. Lowe is deficient because it not only disarms with the ignition in the on position, giving children the opportunity to press the deactivator for the driver, it also only arms if the warning lights have been used, providing no protection on field trips, athletic runs, or other trips where the warning lights are not used.

### SUMMARY OF THE INVENTION

It is thus the object of the present invention to provide an alarm system on a vehicle to remind the driver of the vehicle to conduct an inspection of the inside of the vehicle to check for passengers remaining inside. The invention would require the driver to walk to the back of the vehicle before exiting at the end of their run if either the ignition had been in the on position for a set period of time or longer, or the vehicle speed had exceeded a pre-determined value. It is a further object of the present invention to provide a means for service personnel to quickly and easily verify that the system is functional and has not been disabled. It is a further object of the present invention to provide means for automatically illuminating the interior of the vehicle to aid the driver during their walk to the rear of the vehicle. It is a further object of the present invention to disable deactivation means at the rear section of the vehicle if the system is in the alarm state.

### BRIEF DESCRIPTION OF DRAWINGS

FIG. 1 is a top view of a vehicle fitted with the alarm system according to the present invention. In FIG. 1, the bus driver's seat is indicated generally as 12. The principal elements of the invention are the audible horn 17, ignition key 14, entrance door 16, control module 15, visual system status indicator 13, interior lights 11a and 11b, and deactivator means 10.

### DETAILED DESCRIPTION

In one aspect of the invention, there is provided an alarm system for use on a vehicle designed to carry a plurality of passengers. The alarm system is arranged so it is normally in a standby state, and will enter a set state when the ignition has been on for a pre-determined length of time, or the vehicle speed has exceed a pre-determined value. The system will enter an armed state only from the set state, and will only do so once the ignition has been turned off. The system will enter an alarm state if it is left in the armed state for a pre-determined length of time, or an exit door is opened. The system can only be removed from the alarm state by turning the ignition key to the on or accessory positions. The system can be removed from the armed state by either turning the ignition key to the on or accessory positions, or by cycling a deactivation means in the rear section of the vehicle. The system will automatically turn on the interior lights of the vehicle during the time the visual sweep is to be conducted.

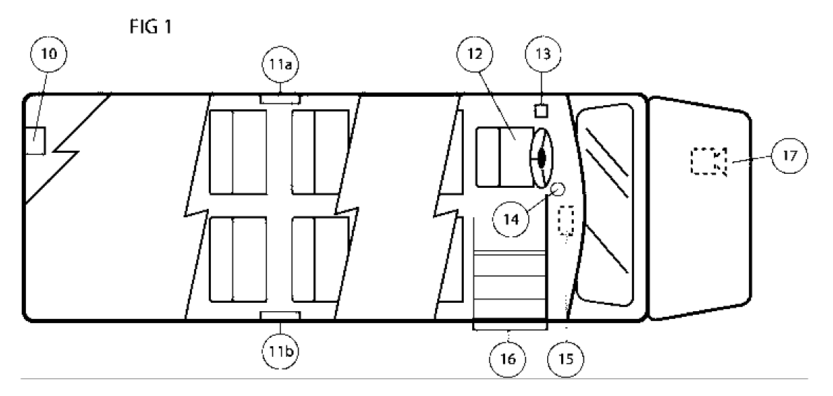

In FIG. 1, the bus driver's normal seat location is indicated generally as 12. A typical mounting location for the control module 14 is behind the dashboard of the vehicle, out of view of the driver. In one aspect of the invention, the system will enter the set state after the vehicle ignition key 14 has been in the on or accessory positions for a pre-determined period of time, or the vehicle has traveled at a speed in excess of a pre-determined value. When the system is in the set state and the ignition key 14 is turned to the off position, the system will enter the armed state and turn on the vehicle interior lights 11a and 11b, as well as a light indicator 13 mounted in plain view of the driver. Once in the armed state the system will monitor the entrance door 16 and the deactivation means 10 positioned towards the rear of the vehicle. If the entrance door 16 is opened when the system is in the armed state, the system will enter the alarm state and immediately begin sounding the audible alarm 17. The only way to remove the system from the alarm state is to turn the ignition key 14 to the on or accessory positions, placing the driver back inside the vehicle. If the rear deactivation means 10 is cycled when the system is in the armed state, the system will enter a standby state and will allow entrance door 16 to be opened without sounding the alarm. The system will leave interior lights 11a and 11b illuminated for an additional period of time to aid the driver visually as they exit the vehicle. When in the standby state, the system will illuminate interior lights 11a and 11b when entrance door 16 is opened, providing courtesy lighting to the driver when first boarding the vehicle. The system will automatically extinguish interior lights 11a and 11b after a pre-determined period of time to eliminate the possibility of draining the vehicle battery. If service door 16 is opened and closed twice quickly while the system is in the standby state, the system will sound alarm 17 briefly to provide feedback that the system is functioning properly.

1. An alarm system to remind a driver to inspect a vehicle for remaining passengers, said alarm system comprising an electrical circuit arranged to effect a standby state in which the alarm system monitors vehicle activity for conditions to effect a set state, a set state that can only be entered by either having the vehicle ignition on for a pre-determined period of time, or by vehicle speed exceeding a pre-determined value, an armed state that can be changed to a standby state by effecting deactivation means in a location inside the vehicle inaccessible from the drivers seat, and an alarm state which provides alarm means to draw attention to the vehicle.

2. The alarm system of claim 1 wherein the electrical circuit provides means for illuminating the inside of the vehicle.

3. The alarm system of claim 1 wherein the set state can only be entered if all exit doors are closed.

4. The alarm system of claim 1 wherein the electrical circuit provides means for quickly and easily verifying that the system is functioning and not disabled or disconnected.

5. The alarm system of claim 1 wherein the electrical circuit disables the deactivation means while in the alarm state.

6. The alarm system of claim 1 wherein the system will leave the armed state and enter alarm state when an exit door is opened.

7. The alarm system of claim 1 wherein the system will leave the armed state and enter the alarm state after being in the armed state for a pre-determined period of time.

8. The alarm system of claim 1 wherein the armed state can be changed to a standby state by effecting deactivation means with the ignition key in the on or accessory positions.

9. The alarm system of claim 1 wherein the armed state can be changed to a standby state by effecting deactivation means with the ignition key in the off position.

10. The alarm system of claim 1 wherein a means for visual indication of system status is mounted in a location other than the location of the control module.

11. An alarm system to remind a driver to inspect a vehicle for remaining passengers, said alarm system comprising an electrical circuit arranged to effect a standby state in which the alarm system monitors vehicle activity for conditions to effect a set state, an armed state in which the interior lights of the vehicle are illuminated and that can be changed to a standby state by effecting deactivation means in a location inside the vehicle inaccessible from the drivers seat, and an alarm state which provides alarm means to draw attention to the vehicle.

12. An alarm system to remind a driver to inspect a vehicle for remaining passengers, said alarm system comprising an electrical circuit arranged to provide means for quickly and easily verifying that the system is functioning and not disabled or disconnected, and to effect a standby state in which the alarm system monitors vehicle activity for conditions to effect a set state, and an armed state that can be changed to a standby state by effecting deactivation means in a location inside the vehicle inaccessible from the drivers seat, and an alarm state which provides alarm means to draw attention to the vehicle.

13. An alarm system to remind a driver to inspect a vehicle for remaining passengers, said alarm system comprising an electrical circuit arranged to leave the armed state and enter alarm state when an exit door is opened, effect a standby state in which the alarm system monitors vehicle activity for conditions to effect a set state, an armed state that can be changed to a standby state by effecting deactivation means in a location inside the vehicle inaccessible from the drivers seat, and an alarm state which provides alarm means to draw attention to the vehicle.
